(19) United States
(12) Patent Application Publication
(10) Pub. No.: US 2008/0205555 A1
(43) Pub. Date: Aug. 28, 2008

(54) Method and Apparatus for Channel Estimation

(75) Inventors: Xia Zhu, Shanghai (CN); Yan Li, Shanghai (CN); Yanzhong Dai, Shanghai (CN)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/813,865

(22) PCT Filed: Jan. 9, 2006
(86) PCT No.: PCT/IB06/50065

§ 371 Date: Jul. 12, 2007

(30) Foreign Application Priority Data
Jan. 12, 2005 (CN) 200510003924.8

(51) Int. Cl. H04L 27/06; H04L 25/02; H04B 1/707

(52) U.S. Cl. 375/340

(57) ABSTRACT

A channel estimation method, comprising the steps of: receiving radio signals transmitted through wireless channel; calculating the channel fading coefficients of pilot symbols, which inserted in a time slot allocated to the wireless signals; estimating the channel fading coefficients of each of predefined groups of chips in the time slot step by step, by utilizing the channel fading coefficients of the pilot symbols and the correlation between the pilot symbols and traffic data in the time slot, wherein each group of chips is composed of predefined number of chips.

### FIELD OF THE INVENTION

The present invention relates generally to a method and apparatus for channel estimation, and more particularly, to a method and apparatus for estimating the highly time-varying fading channel.

### BACKGROUND OF THE INVENTION

In wireless communication, the energy of received radio signals fades out due to not only the reflection of obstacles or interaction between multi-path signals, but also the rapid fluctuation of instantaneous receiving field intensity caused by user terminals' moving. Therefore, under the impacts of above factors, a wireless channel can be stationary, varying with time slowly, varying with time sharply, etc. In particular, when user terminal receiving high-rate data transmission while in high-speed move, the time-varying effect gets more evident and the wireless channel becomes a highly time-varying fading channel consequently.

When wireless channel varies with time, the dynamic tracking and estimation of the channel characteristics are needed to detect the desired signals more precisely. For example, in TD-SCDMA system, a midamble is inserted as a training sequence between two data fields in a traffic time slot allocated to a transmitted radio signal, as shown in FIG. 1. Thus a receiver utilizes the midamble to perform channel estimation, so as to derive the reference phase and amplitude of the received signal, which named as channel fading coefficient, and in turn yield the desired signal based on the coefficient and correlation detection methods. Another example is, in WCDMA system, pilot bits are inserted in the forepart of the Data Physical Control CHannel (DPCCH) time slot to support the channel estimation when performing correlation detection. The method of periodically inserting pilot chips (such as midamble or pilot bit) into data payload to perform correlation detection is known as pilot symbol assisted modulation (PSAM).

Regarding to conventional wireless communication systems, data transmission rates and moving speed of user terminals are relatively low, so that the Doppler shift is not noticeable. For simplicity, the variance of channel characteristic within a relatively short period, like one time slot (for example, one time slot in TD-SCDMA system shown in FIG. 1 is 675 μs namely 864 chips) can be ignored. In other words, the channel fading coefficient in one time slot can be regarded as a constant. Based on this feature, the conventional wireless communication systems adopt PSAM to estimate the channel fading coefficient of one time slot by using the conventional channel estimation method shown in FIG. 2.

The conventional channel estimation method will be described in the following by taking TD-SCDMA as an example. Firstly, it is assumed that the training sequence yet to be transmitted through wireless channels can be denoted as Ae^{jφ}^{₀}, and after transmission, it rotates with a phase −φ, so the training sequence arriving at receiver would be Ae^{jφ}^{₀}^{-φ}. Secondly, in the channel estimation unit shown in FIG. 2, the signal received on the training sequence Ae^{jφ}^{₀}^{-φ} are first conjugated, denoted as X* in the FIG. 2, after which it is multiplied with the corresponding known training sequence Ae^{jφ}^{₀} to yield a signal Ae^{jφ}, which has the same amplitude as original received training sequence while the phase rotation is opposite to the phase rotation that was experienced by the received signal. Ae^{jφ} is named as channel fading coefficient, wherein A is the reference amplitude of the received signal and φ is the reference phase of the received signal. Finally, after the process of an Infinite Impulse Responder (IIR) filter, an average channel fading coefficient can be yielded as the channel fading coefficient of the whole time slot.

Using the channel estimation method shown in FIG. 2, it is easily to estimate the constant channel fading coefficient in one time slot. It is typically applied in traditional RAKE receivers to obtain the channel fading coefficient of each finger of RAKE receiver, which named as weight factor, through channel estimation. The multi-path effect on the received signal is cancelled by weighted combination and the desired signal is obtained by judgment and recovery process in subsequent processing units.

However, with the development of the wireless technology and increasing customer requirements, a new generation wireless communication system is demanded to provide high-rate data transmission while in a high-speed move. For instance, the third-generation partnership project (3GPP) for 3G (the third generation) wireless systems requires the 1.2M-5 Mb/s data transmission at the user terminal's speed of 120 km/h, and in such environment, the channel characteristic is expected to vary dramatically with time.

FIG. 3 illustrates the fading characteristics of received signals, in TD-SCDMA system, while the moving speed of the user terminal is 120 km/h. In FIG. 3, the ordinate shows the normalized magnitude of received signals (unit: dB) and the abscissa denotes time (unit is time for one chip). FIG. 3, within one time slot (864 chips) in TD-SCDMA system, the magnitude of the received signals decreases 1.6 dB with nonlinear variance approximately. This is due to high-rate data transmission and high moving speed of user terminal, which makes the Doppler shifts not negligible. Therefore, the channel characteristic in one time slot will varies dramatically with time rather than constantly as a constant.

In the circumstance shown in FIG. 3, if still using the conventional channel estimation method shown in FIG. 2 and ignoring the variance of channel characteristics in one time slot, the error of channel estimation will exceed the acceptance limit and cause the BER of received signals increasing. Furthermore, even with relatively high SNRs, the demodulated signals cannot reach the relatively low BER, which degrades the system performance.

Based on above analysis, conventional channel estimation methods are not suitable for the channel estimation in highly time-varying fading environment, therefore a channel estimation method which can detecting the channel variance within one time slot is needed for precisely estimating a highly time-varying fading channel.

### OBJECT AND SUMMARY OF THE INVENTION

An object of the present invention is to provide a method and apparatus for channel estimation suitable for highly time-varying fading channels, by which the variance of the channel characteristics in one time slot can be detected to facilitate the data recovery precisely.

In order to realize the object, the present invention provides a channel estimation method, comprising the steps of: receiving a radio signal transmitted through wireless channel; calculating channel fading coefficients of pilot symbols, which are inserted in a time slot allocated to the radio signal; estimating channel fading coefficients of each of predefined groups of chips in the time slot step by step by utilizing the channel fading coefficients of the pilot symbols and the correlation between the pilot symbols and traffic data in the time slot, wherein each group of chips comprises predefined number of chips.

In order to realize the object, the present invention provides a channel estimation module, comprising: a receiving unit, for receiving a radio signal transmitted through wireless channel; a calculating unit, for calculating channel fading coefficients of pilot symbols, which are inserted in a time slot allocated to the radio signal; an estimating unit, for estimating channel fading coefficients of each of predefined groups of chips in the time slot step by step, by utilizing the channel fading coefficients of the pilot symbols and the correlation between the pilot symbols and traffic data in the time slot, wherein each group of chips comprises predefined number of chips.

In order to realize the object, the present invention provides a receiver, comprising: a plurality of RAKE fingers, for receiving radio signals; a channel estimation module, for estimating the channel characteristic of each RAKE finger, which comprising: a receiving unit, for receiving a radio signal transmitted through wireless channel from RAKE fingers; a calculating unit, for calculating channel fading coefficients of pilot symbols, which are inserted in a time slot allocated to the radio signal; an estimating unit, for estimating channel fading coefficients of each of predefined groups of chips in the time slot step by step, by utilizing the channel fading coefficients of the pilot symbols and the correlation between the pilot symbols and the traffic data in time slot, wherein each group of chips comprises predefined number of chips; a weighted combination unit, for combining the plurality of RAKE fingers by weight according to the channel fading coefficients derived in the channel estimation module; a recovering unit, for recovering desired user data from signals outputted from the weighted combination unit.

In order to realize the object, the present invention provides a mobile terminal, comprising: a transmitter, for transmitting radio signals; a receiver, further comprising: a plurality of RAKE fingers, for receiving radio signals; a channel estimation module, for estimating the channel characteristic of each RAKE finger, which further comprising: a receiving unit, for receiving a radio signal transmitted through wireless channel from RAKE fingers; a calculating unit, for calculating channel fading coefficients of pilot symbols, which are inserted in a time slot allocated to the radio signal; an estimating unit, for estimating channel fading coefficients of each of predefined groups of chips in the time slot step by step, by utilizing the channel fading coefficients of the pilot symbols and the correlation between the pilot symbols and the traffic data in time slot, wherein each group of chips comprises predefined number of chips; a weighted combination unit, for combining the plurality of RAKE fingers by weight according to the channel fading coefficients derived in the channel estimation module; a recovering unit, for recovering desired user data from signals outputted from the weighted combination unit.

Other objects and attainments together with a fully understanding of the invention will become apparently and appreciated by referring to the following description and claims taken in conjunction with the accompanying drawings.

### BRIEF DESCRIPTION OF THE DRAWINGS

Detailed descriptions will be given below to the present invention in conjunction with specific embodiments and accompanying drawings, in which:

FIG. 1 is a schematic diagram illustrating the frame structure in TD-SCDMA system;

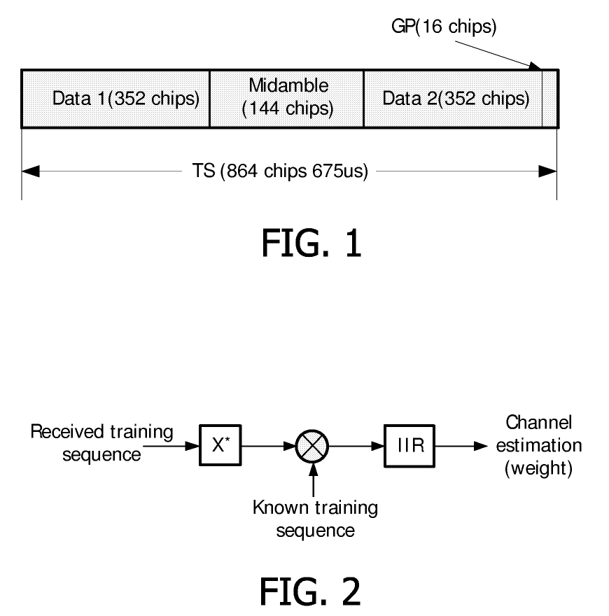

FIG. 2 is a schematic diagram illustrating the method of the traditional channel estimation;

FIG. 3 is the characteristic curve of received signal fading with time when user terminal moves at speed of 120 Km/h;

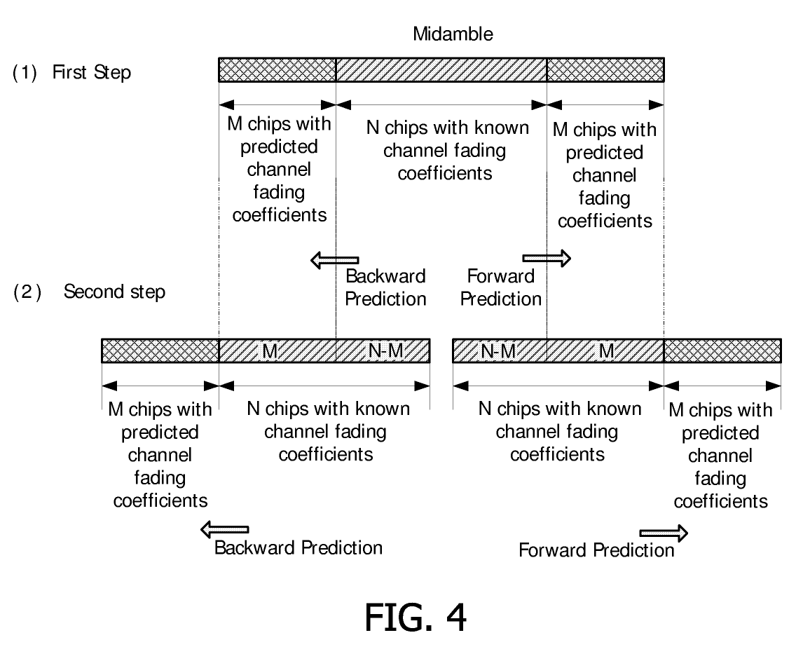

FIG. 4 is schematic diagram illustrating the process for using of sliding window to perform channel estimation according to an embodiment of the present invention;

FIG. 5 is schematic diagram illustrating the structure of RAKE receiver according to an embodiment of the present invention;

FIG. 6 is a flowchart illustrating the process for using sliding window to perform wireless channel estimation by RAKE receiver according to an embodiment of the present invention.

Throughout the drawing figures, like reference numerals will be understood to refer to like parts and components.

### DETAILED DESCRIPTION OF THE INVENTION

According to the 3GPP specification, user terminal is demanded to have the capability to support high-rate data transmission while in a high-speed move. Therefore, due to Doppler shift, the channel fading coefficient in one time slot can not be regarded as a constant, and the variance of the channel characteristic in one time slot needs to be reflected. For such purpose, the minimal detection period of the channel fading coefficient should be less than the duration of one time slot, for example, the channel fading coefficient in one chip period of a time slot could be approximately regarded a constant.

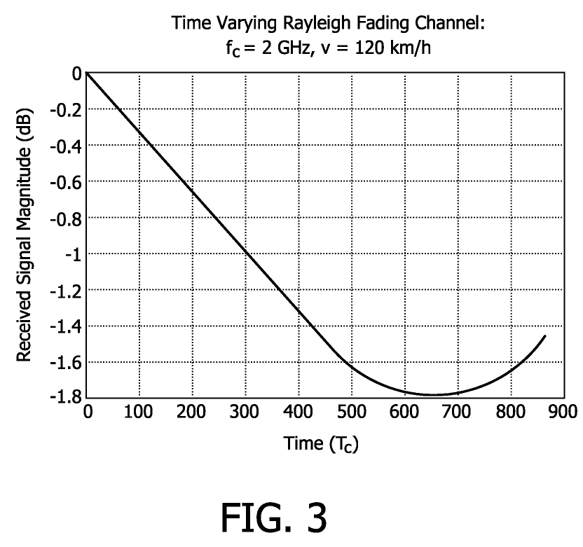

According to the abovementioned conventional channel estimation method, receiver calculates the pilot symbols' channel fading coefficients in one time slot by conjugate multiplying based on the method shown in FIG. 2. In general, the number of pilot symbols in one time slot is limited, so that the channel fading coefficients of pilot symbols are not sufficient to reflect the channel characteristic's variance in one whole time slot completely. However, according to the prediction theory, if there is correlation among signals, known signals can be used to estimate or predict unknown signals. For example, when a wireless channel is a Rayleigh fading channel and conforms to Rayleigh distribution, the channel fading coefficients can be obtained by prediction based on Rayleigh fading channel characteristics.

Based on above consideration, the channel estimation method proposed in the present invention is used to estimate the channel fading coefficient corresponding to each chip in one time slot by predicting correlation among radio signals and utilizing the calculated channel fading coefficients of the pilot symbols, so that the variance of channel characteristic within one time slot is reflected by using the channel estimation method.

TD-SCDMA system will be taken as an example below to describe the channel estimation method. Moreover, the concrete application cases of the channel estimation method as provided in the present invention in RAKE receiver will be given as well.

In TD-SCDMA system, the receiver receives the radio signals transmitted through wireless channel, and the received signals are filtered by a matched filter and sampling, then are inputted into the channel estimation unit designed according to the channel estimation method as provided in the present invention, so as to estimate the channel fading coefficients.

According to the channel estimation method proposed in the present invention, firstly, the known midamble obtained during cell search process is used to calculate the channel fading coefficients of the midamble in traffic time slot. Detailed description is given below:

Normally, filtering the received signal by a matched filter and sampling at proper times can yield (in the embodiment, sampling interval is one chip period) signals expressed in the following equation:

rₖ=cₖsₖ+nₖ (1)

Where sₖ is the originally M-order PSK-modulated (like QPSK or 8PSK) baseband signals. The baseband signals undergo normalized process so that the statistical means E[|sₖ|²]=1. nₖ is a complex Additive White Gaussian Noise (AWGN) sequence with variance N₀. cₖ is a complex Gaussian multiplicative distortion, that is, the distortion of the originally transmitted signal after transmission through wireless channel. In other words, cₖ is the channel fading coefficient to be calculated or predicted by channel estimation.

It is assumed that sₖ is known midamble, after multiplying the conjugate of the midamble s*ₖ, the midamble in received signals is:

zₖ=rₖs*ₖ=(cₖsₖ+nₖ)s*ₖ=cₖ+nₖs*ₖ=cₖ=ñₖ (2)

The training sequence in the embodiment contains 144 chips, if neglecting the weak influence of additive noise, we can calculate the channel fading coefficients {c₁, c₂, . . . c_{N}} in case N=144, according to the Equation (2).

According to the channel estimation method in the present invention, after calculating the channel fading coefficients of midamble, the next step is to estimate the channel fading coefficients of each chip in the time slot utilizing the correlation among radio signals by prediction.

Now briefly introduce the basic method of prediction. There are many kinds of prediction approaches. One of the commonly accepted prediction criterion is Minimum Mean Square Error (MMSE) criterion, i.e. pursuing the square error between the estimated value and the accurate value to be minimized. In MMSE criterion, Wiener Filter is an optimum prediction algorithm, which obtains the estimated value of unknown signals through summing known signals with different weights. For Wiener Filter algorithm, the estimated value, which meets MMSE criterion, is obtained by utilizing the correlations among signals and selecting appropriate weight coefficients. Equation (3) gives the optimum weight vector of the Wiener filter under MMSE criterion:

wₒ=R⁻¹p (3)

Wherein, given known signal vector is denoted by \vec{c}, and unknown signal vector, which to be predicted, is denoted by {circumflex over (\vec{c}, R is the autocorrelation matrix of \vec{c}, and p is the cross-correlation vector between the known signal vector \vec{c} and the unknown signal vector {circumflex over (\vec{c}. According to the correlation among signals, when the wireless channel is Rayleigh fading channel, R and p can be pre-obtained from zero order Bessel function. The desired estimation result {circumflex over (\vec{c} can be calculated by multiplying the weight vector of Wiener Filter and known signal vector \vec{c} as shown in Equation (4)

{circumflex over (\vec{c}=w₀^{H}\vec{c}(4)

Wherein, [.]^{H} denotes the transpose of a matrix. The weighted vector coefficient of Wiener Filter can be determined by correlated matrix. More close the signals correlate, more accurate the Wiener Filter's estimation is. Therefore, utilizing known signals to estimate the value of adjacent signals will achieve more accurate estimation.

In the embodiment, the channel fading coefficients estimation for other chips (the remaining chips except midamble) is realized according to above-mentioned Wiener Filter algorithm. In TD-SCDMA system, midamble (training sequence) is at the center of each time slot and being as a benchmark, therefore after the channel fading coefficients {c₁, c₂, . . . c_{N}} are obtained according to Equation (2), it is needed to predict the channel fading coefficients of other chips preceding or following the benchmark.

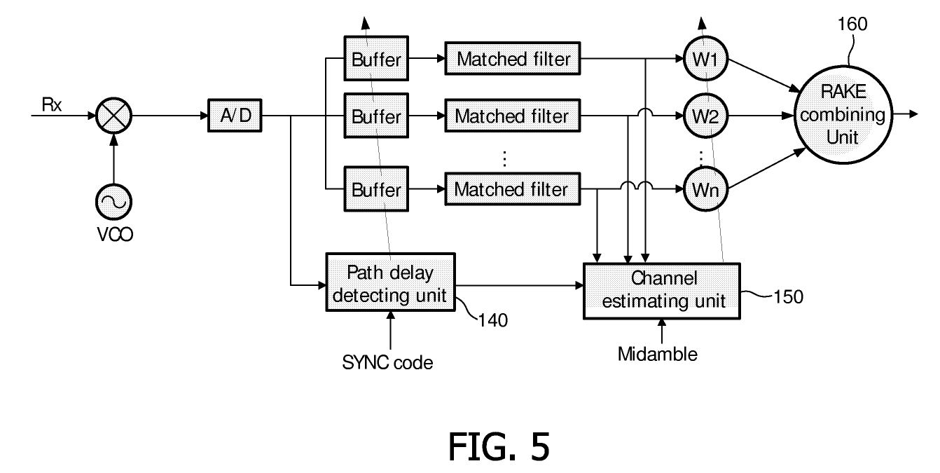

For achieving more precise estimation, the present invention proposes a method of sliding window to perform channel estimation, with basic process illustrated in FIG. 4.

In FIG. 4, firstly, a sliding window is provided on the midamble and the diagonal part denotes the location of the window. In the embodiment, it is supposed that the length of the sliding window is set as the length of the midamble N, say, 144 chips, but the size of the sliding window is not limited to this, in another embodiment, it is allowed to be shorter than the length of midamble. Then, the channel fading coefficients of midamble in sliding window is utilized to estimate the channel fading coefficients of the M chips preceding or following the sliding window, in which, M can be chosen as any natural number less than N. In FIG. 4, the gridding part denotes the M chips of which the channel fading coefficients have been predicted, wherein, predicting the channel fading coefficients of the chips following the midamble is called “forward prediction”, otherwise called “backward prediction”. Hereafter, the method of wireless channel estimation with a sliding window according to the invention will be described in detail around “forward prediction” and “backward prediction”.

As shown in FIG. 4, in the first step, the N chips in midamble are chosen to be included in the sliding window. Taken forward prediction as example first, the channel fading coefficients of M chips, which following the midamble {c_{K+N+1}, c_{K+N+2}, . . . , c_{K+N+M}} (from the (N+1)th chip to (N+M)th chip), can be predicted based on the channel fading coefficient vector \vec{c}=[c₁, c₂, . . . c_{N}]^{T} of midamble obtained by previous calculation, and the unknown channel fading coefficient vector can be denoted as {circumflex over (\vec{c}=[c_{N+1}, c_{N+2}, . . . c_{N+M}]^{T}.

The procedure of utilizing Weiner Filter algorithm to estimate the unknown channel fading coefficients according to known channel fading coefficients has been detailed in above description. Specifically, when the wireless channel is a Rayleigh Fading channel, the autocorrelation matrix R and the cross-correlation matrix p in Equation (3) can be calculated by zero order Bessel function; then, the calculated R, p and the channel fading coefficient vector of the midamble \vec{c}=[c₁, c₂, . . . c_{N}]^{T} are substituted into Equation (4) to yield the channel fading coefficients of M chips {c_{N+1}, c_{N+2}, . . . c_{N+M}} in forward prediction of the first step.

Similarly, utilizing Wiener Filter algorithm, the channel fading coefficients of N chips in midamble can also be used to estimate the channel fading coefficients of N chips, which preceding the midamble, as the backward prediction in the first step shown in FIG. 4.

After obtaining the channel fading coefficients {c_{N+1},c_{N+2}, . . . c_{N+M}} of M chips following the midamble, in the second step, the sliding window is slid forward by M chips to be located from the (M+1)th chip of the midamble to the Mth chip following the midamble. Since the window slides by M chips forward, the sliding window includes the N-M midamble and the M chips of which the channel fading coefficients were just obtained by the first step, shown as the diagonal part in the forward prediction of the second step in FIG. 4.

According to above method, the channel fading coefficients of N chips within current sliding window, namely, the channel fading coefficients of the N-M midambles {c_{M+1}, c_{M+2}, . . . c_{N}} and the channel fading coefficients of M chips {c_{N+1}, c_{N+2}, . . . c_{N+M}} obtained by the first step can be used to predict the channel fading coefficients of M chips (from the N+M+1 chip to the N+2M chip) following the sliding window. Then, the sliding window is slid forward by M chips once again, and also according to the channel fading coefficients of each chip in the sliding window, the channel fading coefficients of M chips following the sliding window can be predicted. By sliding the sliding window forward by M chips the channel fading coefficient of each chip following the midamble in the time slot can be predicted step by step.

Similarly, after the first step of backward prediction is completed, through sliding the sliding window backward by M chips (the sliding window is shown as the diagonal part of backward prediction in the second step of FIG. 4 and the M chips are shown as the gridding part preceding the sliding window), the channel fading coefficients of N chips within the sliding window, namely, the N-M fading coefficients of the midamble {c₁, c₂, . . . c_{N-M}} and the channel fading coefficients of M chips obtained by the first step, can be used to estimate the M chips preceding the sliding window. Moreover, through sliding M chips backward the sliding window can predict the channel fading coefficient of each chip preceding the midamble in the time slot step by step.

Through above forward prediction and backward prediction, the channel fading coefficients of all chips in the whole time slot can be obtained. Since the channel fading coefficients are estimated by Wiener Filter step by step, it is possible to detect the variance of channel characteristics within one time slot, so as to reflect the characteristics of real channels more accurately.

The above-mentioned channel estimation method according to the present invention is depicted in detail by taken TD-SCDMA as an example. This method can be used in RAKE receiver. In RAKE receiver, the channel estimation method according to the present invention can be used to acquire the channel fading coefficient of each RAKE finger more accurately, which is used as weight factor for combining each finger's signals with suitable weight in the RAKE combing unit, so that multipath effect on the received signals can be cancelled. Below details how the channel estimation method is applied in the RAKE receiver in TD-SCDMA system.

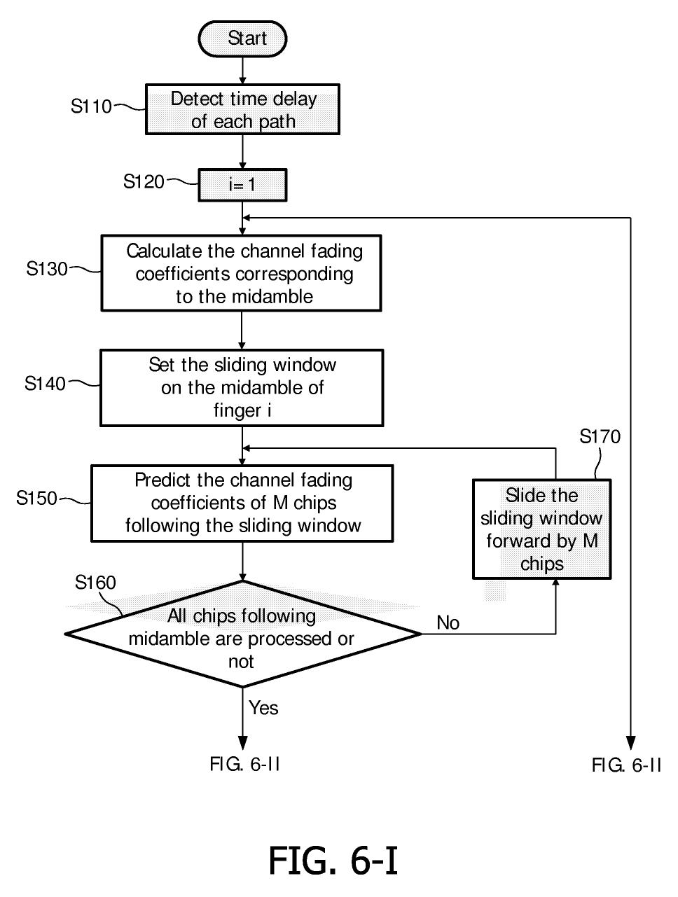

FIG. 5 illustrates the structure of RAKE receiver according to an embodiment of the present invention in TD-SCDMA system;

The cell search unit (not shown) in a user terminal obtains the SYNC_DL used in the cell by cell search, and based on the SYNC_DL to confirm the midamble used in the cell further. Subsequently, the cell search unit sends SYNC_DL and midamble to the RAKE receiver shown in FIG. 5 for detecting multi-path time delay and performing channel estimation.

In RAKE receiver illustrated in FIG. 5, the signals received from an antenna will subject to downlink frequency conversion and analog/digital conversion before the sampled signals is formed, where in the embodiment, the interval of sampled signal is one chip period. Then, path delay detecting unit 140 utilizes the SYNC_DL obtained during cell search to detect each multi-path time delay in the sampled signals, so as to differentiate different path according to the delay information. Subsequently, each finger of RAKE receiver, according to the delay information from path delay detecting unit 140, reads out the signals corresponding to the RAKE finger from the buffer respectively and performs matched filtering. After that, the channel estimation unit 150 adopts the above-mentioned channel estimation method to perform channel estimation for each finger by utilizing the midamble obtained during cell search, so as to get weight factors of channel characteristic on each finger. Eventually, RAKE combing unit 160 will perform weighted combination on each finger signals to obtain the received signals without multipath effect for subsequent process.

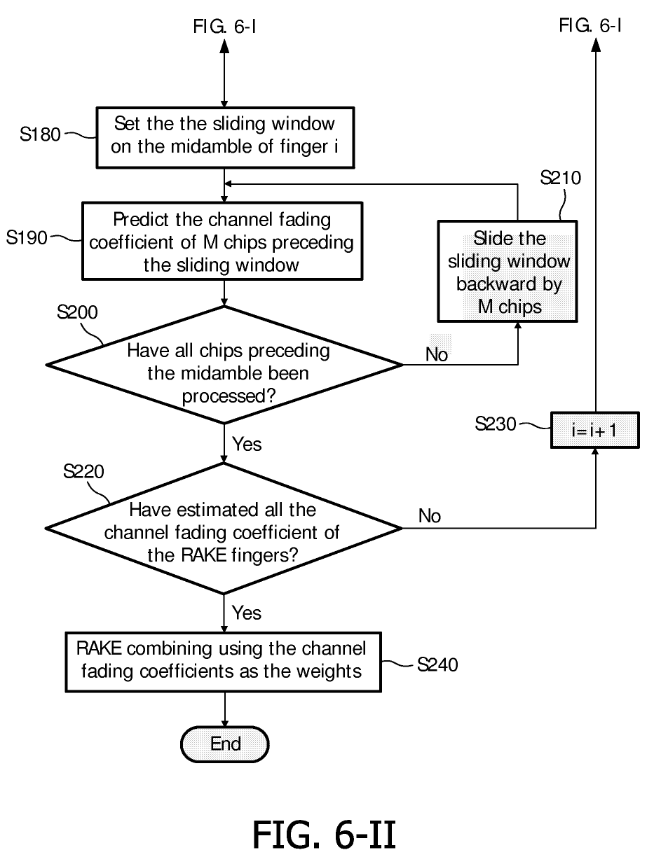

FIG. 6 shows the flow chart of the operation performed by the RAKE receiver for using the channel estimation method proposed in the present invention, and the following describes the operation procedure of the channel estimation method proposed in the present invention in conjunction with FIG. 6, in which the channel estimation method can be applied in above channel estimation unit 150.

As shown in FIG. 6, firstly, in RAKE receiver, the time delay of different paths detected by SYNC code obtained during cell search is used to differentiate the multi-path signals on each path (Step S110). After the multi-path signals are filtered by matched filter, all RAKE fingers with one-time-slot length are sent to channel estimation unit 150 to perform channel estimation to obtain weight factors.

During the channel estimation, when receiving each finger signals, firstly, a counter i for counting RAKE fingers' number is launched, and initialized with 1, i.e., i=1 (Step S120), which means the channel estimation will start from the first RAKE finger. Secondly, the channel fading coefficients of the midamble at the ith finger are calculated by utilizing the known midamble obtained during cell search (Step S130).

Subsequently, the midamble of the first RAKE finger (or say, the No. i RAKE finger) is chosen in a sliding window with length of N, and in the embodiment N is the length of midamble, i.e., N=144. Then, the channel fading coefficients of the midamble in the sliding window are used to estimate the channel fading coefficients of M chips following the sliding window (Step S150) by Winder Filter algorithm, shown in the forward prediction of the first step in FIG. 4. After that, it is to be judged whether the estimation of the channel fading coefficients of all the chips following the midamble has been processed (Step S160). If the channel fading coefficients of some chips following the midamble are still unknown, the sliding window slides forward by M chips, i.e. to the position indicated by the forward prediction of the second step in FIG. 4, to make the sliding window cover the M chips of which the channel fading coefficients have been estimated in Step S150, and the channel fading coefficients of N-M chips in original sliding window (Step S170), and then continue to execute Step S150.

If the estimation of channel fading coefficients of all the chips following the midamble has been processed, the sliding window will be reset to the midamble of the No. i finger (Step S180). And then, the channel fading coefficients of the chips in the sliding window are used to predict the channel fading coefficients of M chips preceding the window (Step S190), as shown in the backward prediction of the first step in FIG. 4. After the prediction is finished, it is to be judged if all the channel fading coefficients of chips preceding the midamble have been estimated (Step S200). Using the method same as forward prediction, if there is some channel fading coefficients of chips preceding the midamble unknown, the sliding window continues to slide backward by M chips (Step S210) and returns to step S190 for further prediction.

If the entire channel fading coefficients preceding the midamble are obtained, it is to be detected if the channel fading coefficients of all the RAKE fingers have been estimated (Step S220). If there are uncalculated RAKE fingers, then the counter i adds 1 (Step S230) and returns to step S130 to continue the next RAKE finger estimation. If the estimation of all the RAKE fingers has been done, the channel fading coefficients of each RAKE finger will be used as weight factor to be multiplied with each corresponding RAKE finger's signals before combined in RAKE combining unit 160, so as to obtain the optimum received signal (Step S240).

It needs to be noted that the minimal detectable period of channel fading coefficients is one chip period in this embodiment, in other words, the channel fading coefficient corresponds to each chip in one time slot. But practical application is not limited to this. For example, when the variance of channel characteristics slows down, in order to speed up the pace of channel estimation, the channel fading coefficients in the time interval of a group of chips (comprises multiple chips) can be regarded roughly as a constant, that is, the channel fading coefficient corresponds to each group of chips in one time slot. Wherein, the number of chips contained in a group can be set according to real channel variance situation when performing channel estimation.

Besides, in the embodiment, it is supposed that the sampling interval for received signals is one chip period, thus when the length N of sliding window is set to be equal to the number of sampling point in midamble, N=144. Of course the length of sliding window is not limited to the length of the midamble, and the sliding window could also cover part of the midamble for estimating according to this part of the channel fading coefficients of midamble, i.e. the length of sliding window N<144. When over-sampling is taken, namely more sampling points in one chip period, if the length of sliding window N is still equal to the length of the midamble, then N>144.

Besides, the above embodiments only take the RAKE receiver in TD-SCDMA system as one example to describe the concrete application of the channel estimation method proposed in present invention, and the channel estimation method can also be applied in other fields, like joint detection.

Meanwhile, the channel estimation method according to the present invention can also be applied in other systems, such as WCDMA system. If the pilot symbols, in the frame structure of the transmission signals in applied system, are inserted at one end of time slot, as head or end, then the sliding window in the present invention may move forward or backward only.

One example is, in WCDMA system, when pilot bits are inserted at the head of one time slot, the sliding window will move forward and perform the “forward prediction” only. At this time, due to relatively far distance from the signals at the tail part of the time slot, the correlation between the pilot symbols and the signals at the tail part is relatively weak. In order to achieve more accurate channel fading coefficient estimation, the channel estimation can be performed under the help of the pilot symbols in the next time slot. The detailed procedure is: firstly setting the sliding window at the pilot symbols of the next time slot, and then estimating the channel fading coefficients corresponding to the tail part signals of the current time slot by sliding the sliding window backward.

### ADVANTAGES OF THE INVENTION

In conjunction with above figures, TD-SCDMA is taken as an example to describe the channel estimation method in the present invention. It is easily to found that the channel fading coefficients estimated by the channel estimation method according to the present invention correspond to each chip (or each group of chips) in each time slot respectively. Thus the channel fading coefficients in one time slot are not constant any more, and fully reflect the variance of channel characteristics in one time slot period. In particular, when user terminal moves with high speed, the predicted channel fading coefficients could fully reflect the high time-varying characteristic.

Meanwhile, the present invention adopts the sliding window algorithm to estimate the channel fading coefficients step by step. Because the channel estimation algorithm proposed by the present invention uses the correlation among signals to perform estimation and prediction, and the correlation among signals is relatively close, estimating the channel fading coefficients of adjacent limited signals by utilizing known signals can obtain higher precision and more accurate results.

Moreover, the channel estimation method according to the present invention adopts the optimum Wiener Filter algorithm under MMSE criterion and utilizes the optimum weight factor of Wiener filter algorithm to estimate unknown channel fading coefficients, and the outcome is much closer to real channel characteristic.

It is to be understood by those skilled in the art that channel estimation method and apparatus as disclosed in this invention can be made of various modifications without departing from the spirit and scope of the invention as defined by the appended claim.

1. A channel estimation method, comprising the steps of:
receiving a radio signal transmitted through wireless channel;
calculating channel fading coefficients of pilot symbols, which are inserted in a time slot allocated to the radio signal; and
estimating channel fading coefficients of each of predefined groups of chips in the time slot step by step by utilizing the channel fading coefficients of the pilot symbols and the correlation between the pilot symbols and traffic data in the time slot, wherein each group of chips comprises predefined number of chips.

2. The channel estimation method according to claim 1, wherein the group of chips comprises at least one chip.

3. The channel estimation method according to claim 1, wherein estimating channel fading coefficients comprises:
estimating channel fading coefficients of a group of chips, which correlates with the predefined number of pilot symbols, by utilizing the channel fading coefficients of the predefined number of the pilot symbols; and
estimating the channel fading coefficients of other groups of chips, which correlate with the group of chips, by utilizing the channel fading coefficients of the group of chips, so as to predict the channel fading coefficients of each predefined group of chips in the time slot step by step.

4. The channel estimation method according to claim 3, wherein the channel fading coefficients of the other groups of chips are estimated by utilizing the channel fading coefficients of the pilot symbols, which correlate with the other group groups of chips.

5. The channel estimation method according to claim 3, wherein the group of chips that correlates with the pilot symbols comprises chips preceding the pilot symbols, or chips following the pilot symbols in the time slot.

6. The channel estimation method according to claim 3, wherein Wiener filter algorithm is used to estimate the channel fading coefficients of the group of chips.

7. The channel estimation method according to claim 6, wherein Minimum Mean Square Error (MMSE) criterion is used to obtain the channel fading coefficients in the Wiener filter algorithm.

8. The channel estimation method according to claim 3, wherein the predefined number of pilot symbols are the total pilot symbols.

9. The channel estimation method according to claim 1, wherein the wireless channel is Rayleigh fading channel.

10. A channel estimation module, comprising:
a receiving unit, for receiving a radio signal transmitted through wireless channel;
a calculating unit, for calculating channel fading coefficients of pilot symbols, which are inserted in a time slot allocated to the radio signal;
an estimating unit, for estimating channel fading coefficients of each of predefined groups of chips in the time slot step by step, by utilizing the channel fading coefficients of the pilot symbols and the correlation between the pilot symbols and traffic data in the time slot, wherein each group of chips comprises predefined number of chips.

11. The channel estimation module according to claim 10, wherein the estimating unit utilizes the channel fading coefficients of the predefined number of the pilot symbols to estimate the channel fading coefficients of a group of chips, which correlates with the predefined number of the pilot symbols; and
estimates the channel fading coefficients of other groups of chips, which correlate with the group of chips, by utilizing the channel fading coefficients of the group of chips, so as to predict the channel fading coefficients of each predefined group of chips in the time slot step by step.

12. The channel estimation module according to claim 11, wherein the estimating unit estimates the channel fading coefficients of the other groups of chips by utilizing the channel fading coefficients of the pilot symbols, which correlates with the other groups of chips.

13. The channel estimation module according to claim 11, wherein the group of chips that correlates with the pilot symbols comprises chips preceding the pilot symbols, or chips following the pilot symbols in the time slot.

14. The channel estimation module according to claim 13, wherein the estimating unit utilizes Wiener filter algorithm to estimate the channel fading coefficients of the group of chips.

15. The channel estimation module according to claim 14, wherein the Wiener filter algorithm uses MMSE criterion to obtain the channel fading coefficients.

16. A receiver, comprising
a plurality of RAKE fingers, for receiving radio signals;
a channel estimation module, for estimating the channel characteristic of each RAKE finger, which comprising:
a receiving unit, for receiving a radio signal transmitted through wireless channel from RAKE fingers;
a calculating unit, for calculating channel fading coefficients of pilot symbols, which are inserted in a time slot allocated to the radio signal;
an estimating unit, for estimating channel fading coefficients of each of predefined groups of chips in the time slot step by step, by utilizing the channel fading coefficients of the pilot symbols and the correlation between the pilot symbols and the traffic data in time slot, wherein each group of chips comprises predefined number of chips;
a weighted combination unit, for combining the plurality of RAKE fingers by weight according to the channel fading coefficients derived in the channel estimation module; and
a recovering unit, for recovering desired user data from signals outputted from the weighted combination unit.

17. A receiver according to claim 16, wherein the estimating unit utilizes the channel fading coefficients of the predefined number of the pilot symbols to estimate channel fading coefficient of a group of chips, which correlates with the predefined number of the pilot symbols; and
estimates the channel fading coefficients of other groups of chips, which correlate with the group of chips, by utilizing the channel fading coefficients of the group of chips, so as to predict the channel fading coefficients of each group of chips in the time slot step by step.

18. The receiver according to claim 17, wherein the estimating unit estimates the channel fading coefficients of the other groups of chips by utilizing the channel fading coefficients of the pilot symbols, which correlate with the other groups of chips.

19. The receiver according to claim 18, wherein the group of chips that correlates with the pilot symbols comprises chips preceding the pilot symbols, or chips following the pilot symbols in the time slot.

20. The receiver according to claim 19, wherein the estimating unit utilizes Wiener filter algorithm to estimate the channel fading coefficients of the group of chips.

21. A mobile terminal, comprising:
a transmitter, for transmitting radio signals;
a receiver, further comprising:
a plurality of RAKE fingers, for receiving radio signals;
a channel estimation module, for estimating the channel characteristic of each RAKE finger, which further comprising:
a receiving unit, for receiving a radio signal transmitted through wireless channel from RAKE fingers;
a calculating unit, for calculating channel fading coefficients of pilot symbols, which are inserted in a time slot allocated to the radio signal;
an estimating unit, for estimating channel fading coefficients of each of predefined groups of chips in the time slot step by step, by utilizing the channel fading coefficients of the pilot symbols and the correlation between the pilot symbols and the traffic data in time slot, wherein each group of chips comprises predefined number of chips;
a weighted combination unit, for combining the plurality of RAKE fingers by weight according to the channel fading coefficients derived in the channel estimation module; and
a recovering unit, for recovering desired user data from signals outputted from the weighted combination unit.

22. A mobile terminal according to claim 21, wherein the estimating unit utilizes the channel fading coefficients of the predefined number of the pilot symbols to estimate channel fading coefficient of a group of chips which correlate with the predefined number of the pilot symbols; and
estimates the channel fading coefficients of other groups of chips, which correlate with the group of chips, by utilizing the channel fading coefficients of the group of chips, so as to predict the channel fading coefficients of each group of chips in the time slot step by step.

23. The mobile terminal according to claim 22, wherein the group of chips that correlates with the pilot symbols comprises chips preceding the pilot symbols, or chips following the pilot symbols in the time slot.
